(19) United States
(12) Patent Application Publication
(10) Pub. No.: US 2015/0003458 A1
(43) Pub. Date: Jan. 1, 2015

(54) Boarder Gateway Protocol Signaling to Support a Very Large Number of Virtual Private Networks

(71) Applicant: Futurewei Technologies, Inc., Plano, TX (US)

(72) Inventors: Renwei Li, Fremont, CA (US); Lin Han, San Jose, CA (US)

(21) Appl. No.: 14/317,560

(22) Filed: Jun. 27, 2014

Related U.S. Application Data
(60) Provisional application No. 61/840,225, filed on Jun. 27, 2013.

(51) Int. Cl. H04L 12/723; H04L 12/46

(52) U.S. Cl. CPC H04L 45/507; H04L 12/4645
USPC 370/392

(57) ABSTRACT

Disclosed herein are example embodiments for Boarder Gateway Protocol (BGP) signaling in virtual private network (VPN) communications. For example, a first network element may encode Multiprotocol Label Switching (MPLS) information in a Network Layer Reachability Information (NLRI) label field that is longer than 24 bits, and transmit a BGP update message comprising a BGP attribute to a second network element. The BGP attribute comprises the NLRI and a specific Subsequent Address Family Identifier (SAFI) value. The specific SAFI value signals to the second network element, upon reception of the BGP update message by the second network element, that the NLRI label field is more than 24 bits long.

### CROSS-REFERENCE TO RELATED APPLICATIONS

The present application claims benefit of U.S. Provisional Patent Application No. 61/840,225 filed Jun. 27, 2013 by Renwei Li et al. and entitled “Board Gateway Protocol Signaling to Support a Very Large Number of Virtual Private Networks,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Increasing consumer and business adoption of cloud computing and storage has pushed data centers to support an ever-increasing number of customers. To do so, the data centers create virtual networks for these customers using virtualization encapsulation methods and protocols, such as Virtual Extensible Local Area Network (VXLAN), Network Virtualization using Generic Routing Encapsulation (NVGRE) and Network Virtualization Overlays over Layer 3 (NVO3) that may be standardized to support several million virtual networks (e.g. about 16 million virtual networks each). To connect to these several million networks, customers may connect through a Provider Edge (PE) device. The PE device may use virtual private network (VPN) labels to locate the associated virtual routing and forwarding (VRF) table entry for forwarding the customer's VPN packet. These VPN labels may be Multiprotocol Label Switching (MPLS) labels as described in Internet Engineering Task Force (IETF) Request for Comments 3032 (RFC 3032), which is incorporated herein by reference as if reproduced in its entirety.

The MPLS labels are represented as a label stack or sequence of label stack entries: a 20-bit Label Value that indicates a forwarding address for a data packet, a 3-bit Experimental Use value, an 1-bit Bottom of Stack value indicating the last label in the MPLS label stack, and an 8-bit Time to Live value. However, this current MPLS label format that is widely used and accepted is only capable of supporting up to about one million of the labels that are used to uniquely address the numerous virtual networks in a data center. When, for example, a Border Gateway Protocol (BGP)/MPLS Internet Protocol (IP) VPN method is used by an enterprise or customer to access its corresponding virtual networks, more than one million labels (e.g. about 16 million labels) may be required to map the VPN labels to Virtual Network Identifiers. Unfortunately, the current 20-bit VPN labels may not be enough to map to all of the virtual network identification space.

### SUMMARY

In an example embodiment, the disclosure includes a first network element that encodes Multiprotocol Label Switching (MPLS) information in a Network Layer Reachability Information (NLRI) label field that is longer than 24 bits, and transmits a BGP message (e.g., a BGP update message) comprising a BGP attribute to a second network element. The BGP attribute comprises the NLRI and a specific Subsequent Address Family Identifier (SAFI) value. The specific SAFI value signals to the second network element, upon reception of the BGP message by the second network element, that the NLRI label field is more than 24 bits long.

In another embodiment, the disclosure includes a network element configured to encode MPLS information in NLRI, the NLRI comprising a label field that is longer than 24 bits and comprises a MPLS label, an address prefix field comprising one or more address prefixes followed by trailing bits such that the variable length prefix occupies an integer number of octets, and a length indicator field indicating a total length in bits of the MPLS label and the one or more address prefixes. The network element is further configured to transmit a BGP message comprising a BGP attribute to a network element, wherein the BGP attribute comprises the NLRI and a specific SAFI value, and wherein the specific SAFI value signals to the network element that the label field is more than 24 bits long.

In yet another embodiment, the disclosure includes a network element comprising a processor configured to encode NLRI comprising a Label field that carries a 4-octet Big Label Value, a Prefix field that contains one or more address prefixes followed by enough trailing bits to make the end of the field fall on an octet boundary, and a Length field that indicates a total length in bits of the Big Label Value plus the one or more address prefixes. The network element further comprises a transmitter coupled to the processor and configured to transmit a BGP message to a network element, wherein the BGP message comprises the NLRI and a SAFI value, and wherein the SAFI value indicates to the network element that the NLRI carries the Big Label Value.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an example embodiment of a VPN.

FIG. 2 is a schematic diagram of an example embodiment of a system where an example embodiment of the present disclosure may operate.

FIG. 3 is a schematic diagram of an example embodiment of a network element.

FIG. 4 is a diagram of one example embodiment of a MPLS Big Label header.

FIG. 5 is a diagram of an example embodiment of an NLRI format.

FIG. 6 is a flowchart of an example embodiment of a method for BGP signaling.

### DETAILED DESCRIPTION

It should be understood at the outset that, although an illustrative implementation of one or more example embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The growth in virtual private networks (VPNs) calls for a new Multiprotocol Label Switching (MPLS) header format to encode packets. The new MPLS header format may contain a label that has a larger size than a traditional MPLS label so that more connections may be identified. To support the new MPLS format for Boarder Gateway Protocol (BGP) MPLS VPN, enhanced Border Gateway Protocol (BGP) signaling may be desired.

Disclosed herein are example embodiments for supporting a MPLS label about 32 bits long in a Network Layer Reachability Information (NLRI) format. The MPLS label may be a Big Label, which may be known herein as a label longer than 24 bits, in contrast with conventional 20-bit labels. In an example embodiment, a NLRI may comprise a prefix field, a label field, and a length field for supporting the MPLS label. The NLRI format (in short as NLRI) for the MPLS label may also coexist with NLRI formats for conventional 20-bit MPLS labels. A new Subsequent Address Family Identifier (SAFI) value may be assigned to the NLRI format for the MPLS label, and may permit a NLRI format based on the MPLS label to be distinguished from a NLRI format based on a 20-bit MPLS label. A BGP speaker may use a BGP Capability Advertisement comprising the new SAFI value to advertise connection capabilities (e.g., that the speaker supports a 32-bit long Big Label Value) to BGP peers while adhering to existing standards of use.

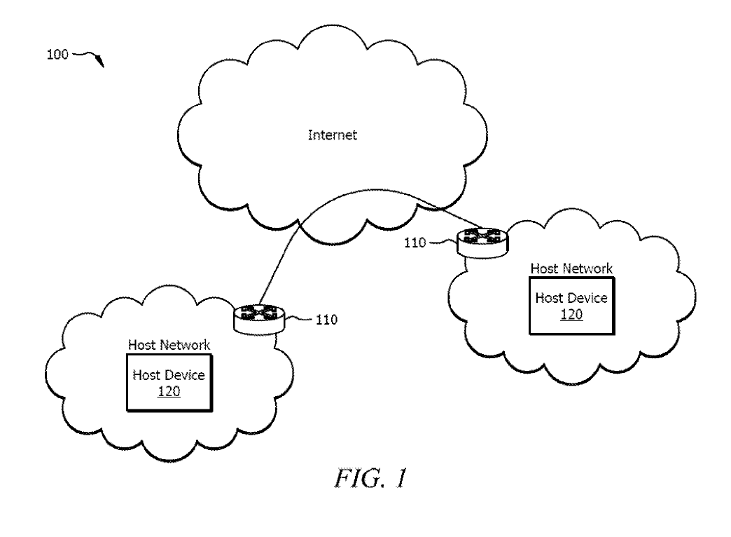

FIG. 1 is a schematic diagram of an example embodiment of a VPN 100 where example embodiments of the present disclosure may operate. The VPN 100 may comprise a plurality of host networks, each having an edge router 110 and a host device 120. The VPN 100 may allow one or more host devices 120 to connect to each other over a public network, e.g. the Internet, while operating as if the host devices 120 were connected directly together in a private network. As such, VPN 100 may allow host devices 120 to connect a geographically diverse site with data centers across core networks with high-performance and security. Edge router 110 may be any network element configured to receive and/or transmit data along one or more paths within the VPN 100. For example, edge router 110 may be a provider edge device, customer edge device, switch, router, bridge, and/or any other device that is used to forward data within the VPN 100. Edge router 110 may determine a VPN customer's prefix and VPN instance to determine the proper routing for a connection in VPN 100. Host devices 120 may be any network element configured to transmit, receive, originate, or terminate data, such as hosts, virtual machines, servers, clients, mobile communications devices, user-equipment, personal computing devices, and/or any other device capable of originating or terminating a VPN connection.

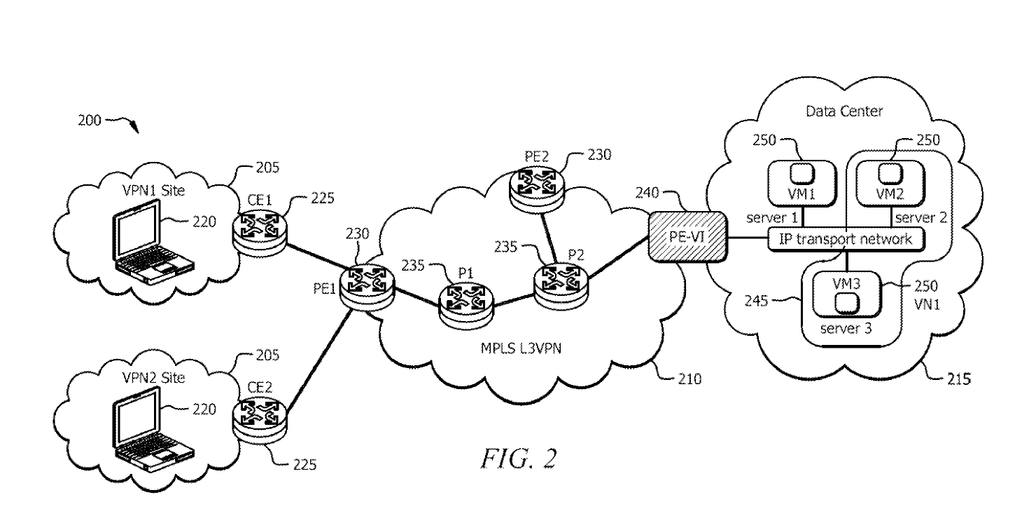

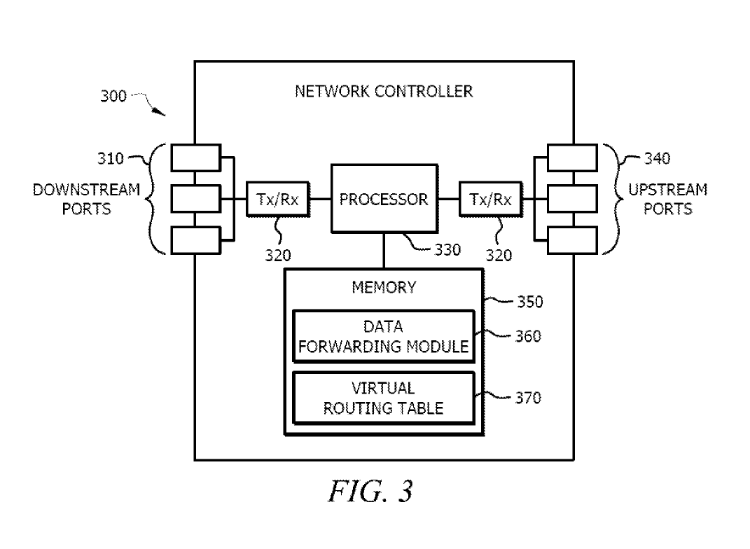

FIG. 2 is a schematic diagram of an example embodiment of a system 200 where an example embodiment of the present disclosure may operate. The system 200 may comprise one or more customer networks 205, a network 210 and a data center 215. Each customer network 205 may include a customer computing device 220 and a Customer Edge (CE) device 225. Customer computing device 220 may be any device that is capable of requesting a VPN connection (e.g. a client, a server, a user-equipment, a mobile communications device, personal computing device, etc.). CE device 225 may be any device that is coupled to one or more PE devices and is capable of transmitting and/or receiving data packets in a data path (e.g. an access point, an access point station, a router, a switch, a gateway, a bridge, etc.). Both customer computing device 220 and CE device 225 may be network elements, as described below in FIG. 3.

Network 210 may be an MPLS layer 3 (L3) VPN that comprises one or more PE devices 230 coupled to or more CE devices 225, one or more transit routers 235 coupled to the PE devices 230, and a PE-Virtual Interface (VI) 240. For exemplary purposes and for greater clarity, network 200 will be described using terminology customarily associated with VXLAN networks; however, it should be apparent to one of ordinary skill in the art that the following description applies generally to a plurality of network protocols (e.g. VXLAN, NVGRE, NVO3, etc.) and is not limited to a VXLAN implementation.

In some example embodiments, network 210 may be referred to as a core network and/or a MPLS core. PE devices 230 may use BGP to distribute VPN routes, maintain VRF tables, and may use MPLS to receive data packets from and/or forward packets to an MPLS network (e.g., network 210). PE device 230, transit router 235, and PE-VI 240 may each be a network element as described below in FIG. 3. In some example embodiments, PE-VI 240 may be a standard PE device such as a PE device 230 coupled to a network virtualization edge (NVE) device, a VXLAN Virtual Tunnel End Point (VTEP), and/or any other device that provides CE functionality to a data center and/or maps data traffic from an incoming network to a virtual network. In these configurations, PE-VI 240 may be considered a gateway between network 210 and data center 215. For example, in a VXLAN network PE-VI 240 may be a device with the combined functionality of a PE and a VXLAN-VTEP that originates and terminates VXLAN tunnels, runs necessary protocols to build and tear down VXLAN tunnels, and maintains VXLAN tunnel forwarding states, including a media access control (MAC) table.

Data center 215 may comprise one or more virtual networks 245, as well as one or more virtual machines 250. Each virtual network 245 and virtual machine 250 may comprise a network element and/or may be implemented in a network element, as described below in FIG. 3. One or more virtual machines 250 may participate in one or more virtual networks 245. In some example embodiments, data center 215 may utilize a VXLAN protocol for network overlay virtualization. In other example embodiments, alternative protocols, such as NVGRE and NVO3, may be utilized for network overlay virtualization.

A customer computing device 220 may communicate with a virtual machine 250 via network 210. The customer computing device 220 may transmit a data packet to CE device 225 that may in turn forward the data packet to one or more PE devices 230. The PE devices 230 may insert an MPLS header between the data packet's layer 2 (L2) and L3 headers according to a destination and origination of the data packet. The MPLS header may comprise one or more MPLS label stack entries, each containing one or more labels. Each label stack entry may be used to provide next hop forwarding information for the data packet. The MPLS header may be an enhanced MPLS header, such that the MPLS header may support addressing for greater than about one million virtual networks. Alternatively, the MPLS header may have the capacity to support addressing for greater than about one million virtual networks but functions in a manner substantially similar to a 20-bit label value MPLS header without utilizing the additional capacity. PE device 230 may then transmit the data packet according to the MPLS header through one or more transit routers 235 until the data packet is received by a second PE device 230. The method of transmitting the data packet through network 210 may be substantially similar to method 600, described below in FIG. 6. Each PE device 230 and transit router 235 in a network 210 that utilizes an enhanced MPLS header, which has the capacity to support addressing for greater than about one million virtual networks, may support receiving, processing, and forwarding that enhanced MPLS header in order to distribute data traffic in network 210. Each PE device 230 and transit router 235 in a network 210 that supports the enhanced MPLS header may also support receiving, processing, and forwarding non-enhanced MPLS headers.

Once the data packet is received by the second PE device 230, the data packet may be forwarded to a CE device in data center 215, and then forwarded to the appropriate virtual network 245 and virtual machine 250. In some example embodiments, the second PE device 230 and a VTEP for data center 215 may be replaced with a single PE-VI 240 device. The PE-VI 240 may serve as a gateway, receiving the data packet from a customer computing device 220 that has been transmitted through network 210 and forwarding the data packet to the virtual network 245 in data center 215, as specified by VXLAN information located in the MPLS header attached to the data packet. The PE-VI 240 may maintain one-to-one mapping information between L3VPN labels and VXLAN Network Identifiers (VNIs) to facilitate receiving data packets from network 210 and forwarding the data packets to data center 215, as well as receiving data packets from data center 215 and forwarding the data packets to network 210. In this embodiment, a data packet header being transmitted out of a PE toward an MPLS network may comprise about three layers: a label switched path (LSP) label, an L3VPN label, and a destination virtual machine IP address. At the PE-VTEP, the layers of the data packet may be mapped to VXLAN VNIs to form a data packet header being transmitted out of the PE-VTEP toward a VXLAN networked data center. The packet may comprise about three layers: an outer label, a VXLAN header or VNI, and an inner label.

In an alternative embodiment, data center 210 may utilize a NVGRE protocol for network overlay virtualization. In this embodiment, PE-VI 240 may instead be referred to as a PE-NVE. A PE-NVE may function substantially similar to a PE-VTEP, and may originate and terminate NVRE packets, maintain NVGRE Virtual Subnet Identifiers (VSIDs), and maintain one-to-one mapping information between L3VPN labels and NVGRE VSIDs. In this embodiment, a data packet header being transmitted out of a PE toward an MPLS network may comprise about three layers: a LSP label, an L3VPN label, and a destination virtual machine IP address. At the PE-NVE, the layers of the data packet may be mapped to NVGRE VSIDs to form a data packet header being transmitted out of the PE-NVE toward a NVGRE networked data center. The packet comprises about three layers: an outer label, a NVGRE header or VSID, and an inner label.

In another embodiment, an L2VPN shared with one or more geographic areas outside of a single date center may be required (e.g. Ethernet-VPN, Q-in-Q, etc.). Virtual local area network (VLAN) Identifiers (VIDs) may be about 12-bit long fields that specify a VLAN to which a data frame belongs, and may allow up to about 4,096 VLAN instances. As an example and without imposing limitation, an enhanced MPLS header that has the capacity to support addressing for greater than about one million virtual networks may be used in a data center local area network (LAN) extension that utilizes L2VPN over an MPLS core network. In this example, the data center may use Institute of Electrical and Electronics Engineers (IEEE) 802.1Q-in-Q VLAN Tag Termination for intranet, as described in IEEE standard IEEE 802.1Q-1998, which is incorporated herein by reference as if reproduced in its entirety. With Q-in-Q may come an added layer of labeling known as a VLAN ID. In this example, a data packet header being transmitted out of a PE-VLAN toward an MPLS network may comprise about three layers: an outer label, a single layer combining an outer VLAN ID, an inner VLAN ID, and an inner label. Double tagged VLAN IDs, or a VLAN ID for an outer VLAN and a VLAN ID for an inner VLAN may require a minimum of an about 24-bit space, and may therefore require an enhanced MPLS header that has the capacity to support addressing for greater than about one million virtual networks. In yet another embodiment, an enhanced MPLS header that has the capacity to support addressing for greater than about one million virtual networks may be utilized to provide one-to-one mapping between VPN labels and NVO3 Virtual Network ID (VNIDs).

In yet another embodiment, an enhanced MPLS header that has the capacity to support greater than about one million addresses may be used to facilitate Fast Reroute protection in a maximally redundant trees multi-topology system. As an example and without imposing limitation, in a topology featuring about three trees, an MPLS label may be required to be globally unique in order to allow fast reroute. With three trees and an estimated 500,000 possible Internet routes per tree, about 1.5 million unique MPLS labels may be required to facilitate fast reroute, requiring an MPLS header capable of supporting greater than about one million addresses.

In yet another embodiment, an enhanced MPLS header that has the capacity to support greater than about one million addresses may be used to facilitate segment routing. A segment identification (SID) may require an about 32-bit long value to use for topological and/or service instructions. An MPLS header with at least an about 32-bit long address label space may properly support the about 4 billion possible segments in a routing domain.

At least some of the features/methods described in this disclosure may be implemented in a network element. For instance, the features/methods of this disclosure may be implemented using hardware, firmware, and/or software installed to run on hardware. The network element may be any device that transports data through a network, e.g., a switch, router, bridge, server, client, etc. FIG. 3 is a schematic diagram of an example embodiment of a network element 300 that may be used to transport and process traffic through at least a portion of a VPN 100, shown in FIG. 1. At least some of the features/methods described in the disclosure may be implemented in a network element. For instance, the features/methods of the disclosure may be implemented in hardware, firmware, and/or software installed to run on the hardware. The network element 300 may be any device (e.g., an access point, an access point station, a router, a switch, a gateway, a bridge, a server, a client, a user-equipment, a mobile communications device, etc.) that transports data through a network, system, and/or domain. Moreover, the terms network “element,” network “node,” network “component,” network “module,” and/or similar terms may be interchangeably used to generally describe a network device and do not have a particular or special meaning unless otherwise specifically stated and/or claimed within the disclosure. In one example embodiment, the network element 300 may be an apparatus configured to implement dynamic multi-destination addressing and/or to establish and communicate data traffic via a radio based connection (e.g., Wi-Fi). For example, network element 300 may be or incorporated within edge router 110 or a host device 120, shown in FIG. 1.

The network element 300 may comprise one or more downstream ports 310 coupled to a transceiver (Tx/Rx) 320, which may be transmitters, receivers, or combinations thereof The Tx/Rx 320 may transmit and/or receive frames from other network nodes via the downstream ports 310. Similarly, the network element 300 may comprise another Tx/Rx 320 coupled to a plurality of upstream ports 340, wherein the Tx/Rx 320 may transmit and/or receive frames from other nodes via the upstream ports 340. The downstream ports 310 and/or the upstream ports 340 may include electrical and/or optical transmitting and/or receiving components. In another embodiment, the network element 300 may comprise one or more antennas coupled to the Tx/Rx 320. The Tx/Rx 320 may transmit and/or receive data (e.g., packets) from other network elements wirelessly via one or more antennas.

A processor 330 may be coupled to the Tx/Rx 320 and may be configured to process the frames and/or determine which nodes to send (e.g., transmit) the packets. In an example embodiment, the processor 330 may comprise one or more multi-core processors and/or memory modules 350, which may function as data stores, buffers, etc. The processor 330 may be implemented as a general processor or may be part of one or more application specific integrated circuits (ASICs), field-programmable gate arrays (FPGAs), and/or digital signal processors (DSPs). Although illustrated as a single processor, the processor 330 is not so limited and may comprise multiple processors. The processor 330 may be configured to communicate and/or process multi-destination frames.

FIG. 3 illustrates that a memory module 350 may be coupled to the processor 330 and may be a non-transitory medium configured to store various types of data. Memory module 350 may comprise memory devices including secondary storage, read-only memory (ROM), and random-access memory (RAM). The secondary storage is typically comprised of one or more disk drives, optical drives, solid-state drives (SSDs), and/or tape drives and is used for non-volatile storage of data and as an over-flow storage device if the RAM is not large enough to hold all working data. The secondary storage may be used to store programs that are loaded into the RAM when such programs are selected for execution. The ROM is used to store instructions and perhaps data that are read during program execution. The ROM is a non-volatile memory device that typically has a small memory capacity relative to the larger memory capacity of the secondary storage. The RAM is used to store volatile data and perhaps to store instructions. Access to both the ROM and RAM is typically faster than to the secondary storage.

The memory module 350 may be used to house the instructions for carrying out the various embodiments described herein. In one embodiment, the memory module 350 may comprise a data forwarding module 360 that may be implemented on the processor 330. In one embodiment, the data forwarding module 360 may be implemented to facilitate content forwarding and processing functions in an MPLS network coupled to one or more virtual networks, such as, an MPLS network coupled to one or more virtual networks via a PE-VI, such as PE-VI 240, shown in FIG. 2, that forwards received data from the MPLS network to the virtual networks according to an MPLS Big Label value and a mapping table. Such mapping information may be maintained in a virtual routing table 370 at the memory module 350. The data forwarding module 360 may read MPLS labels from received data, determine if the read MPLS labels indicate the presence of a MPLS Big Label, and if present, map the MPLS Big Label to virtual network addresses according to relationships and mapping information contained in virtual routing table 370. The data forwarding module 360 may then forward the received data to a next hop destination. The data forwarding module 360 may be implemented using software, hardware, or both and may operate above the IP layer, e.g., linking layer 2 (L2) or linking layer 3 (L3), in the OSI model.

It is understood that by programming and/or loading executable instructions onto the network element 300, at least one of the processor 330, the cache, and the long-term storage are changed, transforming the network element 300 in part into a particular machine or apparatus, for example, a multi-core forwarding architecture having the novel functionality taught by the present disclosure. It is fundamental to the electrical engineering and software engineering arts that functionality that can be implemented by loading executable software into a computer can be converted to a hardware implementation by well-known design rules known in the art. Decisions between implementing a concept in software versus hardware typically hinge on considerations of stability of the design and number of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable will be produced in large volume may be preferred to be implemented in hardware (e.g., in an ASIC) because for large production runs the hardware implementation may be less expensive than software implementations. Often a design may be developed and tested in a software form and then later transformed, by well-known design rules known in the art, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Any processing of the present disclosure may be implemented by causing a processor (e.g., a general purpose multi-core processor) to execute a computer program. In this case, a computer program product can be provided to a computer or a network device using any type of non-transitory computer readable media. The computer program product may be stored in a non-transitory computer readable medium in the computer or the network device. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), compact disc read-only memory (CD-ROM), compact disc recordable (CD-R), compact disc rewritable (CD-R/W), digital versatile disc (DVD), Blu-ray (registered trademark) disc (BD), and semiconductor memories (such as mask ROM, programmable ROM (PROM), erasable PROM), flash ROM, and RAM). The computer program product may also be provided to a computer or a network device using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

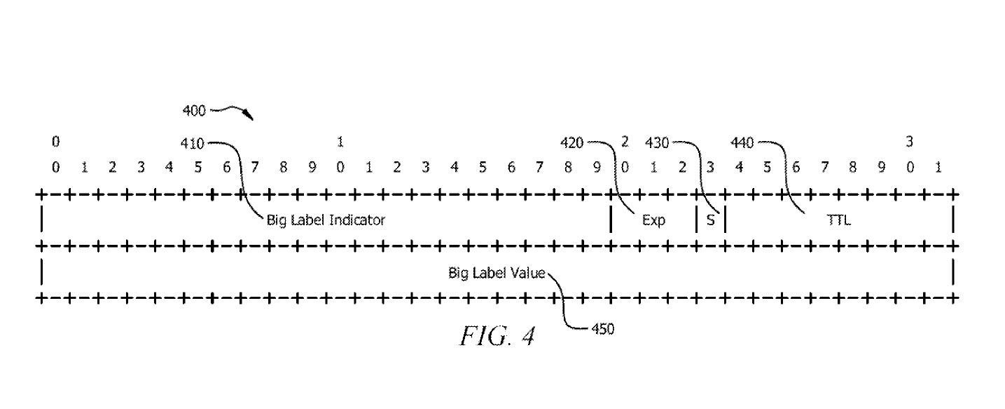

FIG. 4 is a diagram of one example embodiment of a MPLS Big Label header 400. According to RFC 3032, the MPLS Big Label header 400 may represent a label stack that is part of a data packet or an Internet Control Message Protocol (ICMP) message. In some example embodiments, the MPLS Big Label header 400 may facilitate the use of a greater number of virtual network address labels in VPN packet forwarding than are supported in the RFC 3032 MPLS label header. In some example embodiments, MPLS header 400 may be an enhanced MPLS header that has the capacity to support greater than about one million addresses and/or an enhanced MPLS header that has the capacity to support addressing for greater than about one million virtual networks. The MPLS Big Label header 400, which may also be referred to as an MPLS Big Label stack, may comprise a plurality of about 32-bit long MPLS label stack entries, each containing one or more labels 410-450 of varying lengths. In MPLS Big Label header 400, these labels comprise a Big Label Indicator 410, an Experimental Use (Exp) value 420, a Bottom of Stack (S) indicator 430, a Time to Live (TTL) value 440, and a Big Label Value 450. Experimental Use value 420 may be about 3-bits long, Bottom of Stack indicator 430 may be about 1-bit long, and Time to Live may be about 8-bits long, all of which are defined in detail in RFC 3032.

In one example embodiment, the Big Label Indicator 410 may be about a 20-bit long value comprising a reserved MPLS label selected from a reserved, unassigned range of 4-6 and 8-12. In this embodiment, Big Label Indicator 410 may be a value assigned by the Internet Assigned Numbers Authority (IANA). The use of a reserved IANA assigned value may facilitate backward compatibility between MPLS Big Label header 400 and non-Big Label MPLS label headers, thereby preserving the usefulness of existing network hardware. The use of a reserved IANA assigned value may also facilitate interoperability between network elements manufactured by a plurality of independent companies. In an alternative embodiment, Big Label Indicator 410 may be any value commonly known to network elements as a Big Label Indicator and is not limited to an IANA assigned or reserved value. In either example embodiment, the presence of Big Label Indicator 410 may indicate to a network element, such as network element 300 of FIG. 3, that the received MPLS label header is an MPLS Big Label header 400 and the MPLS packet may be forwarded according to Big Label Value 450.

Big Label Value 450 may indicate a next hop over which the VPN packet is to be forwarded, as well as an operation that is to be performed on the VPN packet and other information that may be necessary in order to properly forward the VPN packet. In one example embodiment, Big Label Value 450 may be about 32-bits long. In this embodiment, Big Label Value 450 may be about 32-bits that follow Time to Live value 440 in MPLS Big Label header 400. In another embodiment, Big Label Value 450 may be any length that contains a number of bits capable of uniquely representing a required number of virtual networks. In this embodiment, the first bit of Big Label Value 450 may follow the last bit of Time to Live Value 440. Alternatively, Time to Live Value 440 may be followed by a length indicator which is followed by Big Label Value 450. In this configuration, the length indicator may indicate a length of Big Label Value 450, thereby enabling Big Label Value 450 to be a length that provides a required number of virtual network addresses without requiring unnecessary data overhead in the MPLS Big Label header 400.

For MPLS L3 VPN, a customer's routes may be populated by Multiprotocol Extensions for BGP Version 4 (BGP-4) (MP-BGP), as described in Internet Engineering Task Force (IETF) Request for Comments 2858 (RFC 2858), which is incorporated herein by reference. The routes may be populated as a BGP attribute—Multiprotocol Reachable Network Layer Reachability Information (MP_REACH_NLRI), which is described in IETF RFC 2858. The MP_REACH_NLRI attribute may contain customer site information such as an Address Family Identifier (AFI), SAFI, Network Address of Next Hop, and NLRI. The MPLS label mapping information, which may be used to identify the customer's prefix and VPN instance at each Provider Edge (PE) router, is encoded into NLRI. The encoding format used for this purpose is described in IETF RFC 3107, which is incorporated herein by reference. The format of a MPLS Label is defined in RFC 3032, which is incorporated herein by reference.

In conventional MP-BGP, the NLRI format defines three octets (each octet has 8 bits) for a 20-bit MPLS Label according to IETF RFC 3032, Section 3. The conventional NLRI format may not be usable for the new MPLS header format based on a 20-bit label because the new header may have a label length longer than about 24 bits (e.g., about 32 bits). In order to support BGP signaling with Big Label Values, the NLRI format, SAFI, and BGP capability advertisement may be modified accordingly, as discussed next.

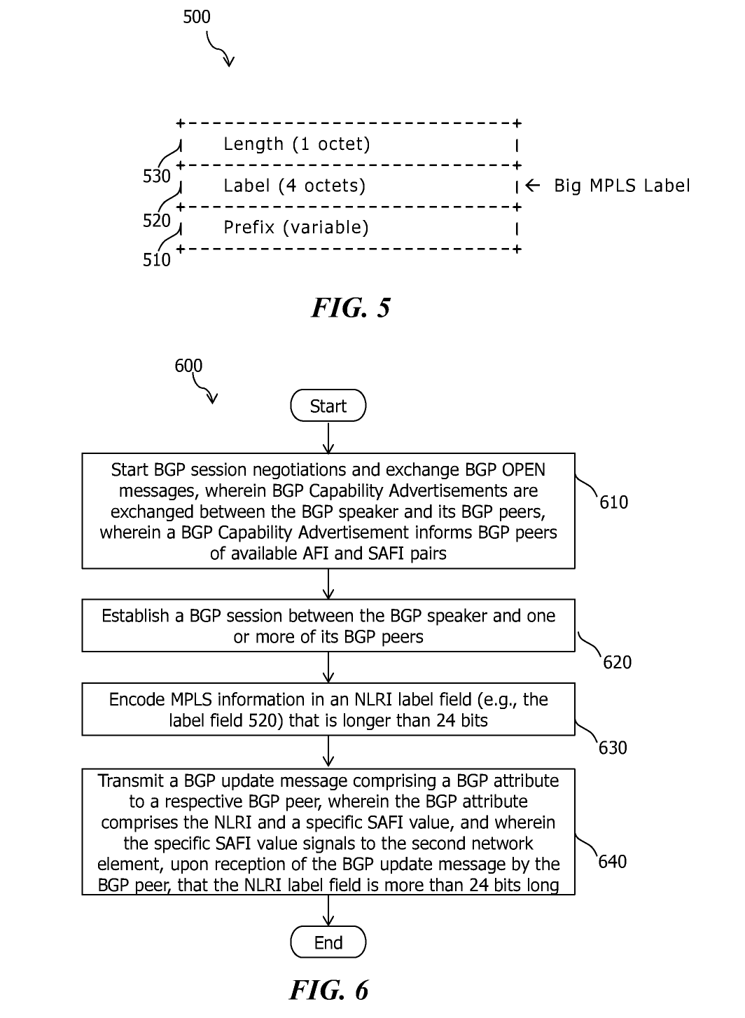

FIG. 5 is a diagram of a new NLRI format 500 according to an example embodiment of this disclosure. The NLRI 500, as defined in RFC 4271 which is incorporated herein by reference, may be part of the MP-BGP attribute MP_REACH_NLRI and may be used to carry a Big Label Value for MP_REACH_NLRI. The NLRI 500 may be used specifically for BGP and may be included in BGP update messages to indicate network layer reachability. BGP messages such as BGP update message and BGP OPEN messages are well-understood by one of ordinary skill in the art, thus detailed discussion is omitted herein in the interest of conciseness. The NLRI 500 may be unique to BGP-4 and may allow BGP to carry super-netting information as well as perform aggregation.

As shown in FIG. 5, an address prefix field 510 may contain one or more address prefixes followed by enough trailing bits to make the end of the field fall on an octet boundary. The value of the trailing bits used in the Prefix field may be irrelevant. A label field 520 may carry an about 4-octet, or 32-bit long Big Label Value of the new MPLS header format. A length field 530 may be one octet long and may indicate the length, in bits, of the address prefix 510 plus the label 520. The usage, rules, and restrictions for prior NLRI, as defined in IETF RFC 3107, section 3, may still apply to the new NLRI format 500. A Big Label Indicator (e.g., the Big Label Indicator 410) may not be carried in the NLRI 500, but instead be assigned by the Internet Assigned Numbers Authority (IANA). In a data plane, when encoding a packet for forwarding, both a Big Label Indicator (e.g., the Big Label Indicator 410) and a Big Label Value (e.g., the Big Label Value 450) may be encoded in the new MPLS header.

The NLRI 500 may maintain backward compatibility with old MPLS labels. In an embodiment, the MPLS label 520 may be about 32 bits long and may comprise a label value (old MPLS label value) that is no more than 20 bits long. In this case, the beginning bits of the MPLS label before the label value are set to zeroes (0's).

To facilitate VPN communications, the fact that the NLRI 500 contains the Big Label Value may be signaled or indicated using a SAFI value. The SAFI value may distinguish the NLRI 500 from other NLRIs that do not contain Big Label Values, and may tell a receiver to use the new NLRI format (with 4-octet label) to interpret the message. The SAFI may be a specific new SAFI used to indicate that the NLRI format 500 carries the 4-octet Big Label Value. The new SAFI may be assigned through the IANA. Currently, an unassigned range of SAFI values is 9-63, so any value in this range may be used as the dedicated SAFI for the new NLRI 500 comprising a Big Label Value. A temporary SAFI value of 9, for example, may be used until an official SAFI value is assigned by the IANA.

The SAFI is introduced in MP-BGP discussed in RFC 4760, which is incorporated herein by reference. There are many SAFI values defined and assigned by IANA. For each new defined SAFI, it is a capability which may be advertised by capability advertisement, according to RFC 3392. The capability advertisement may be included in Optional Parameters of a BGP OPEN message. One BGP OPEN message may include multiple SAFI values to indicate support of multiple capabilities. SAFI may be used in BGP attributes MP_REACH_NLRI and MP_UNREACH_NLRI for BGP update messages. The two attributes used with different SAFIs may allow MP-BGP to support a variety of protocols.

Capability advertisements may be used by a BGP speaker to tell a BGP peer what features it supports. Capabilities may be expressed as an AFI and SAFI combination or pair. For instance, if a BGP speaker supports only IP Version 4 (IPV4), the BGP speaker may only advertise IPV4 AFI and SAFI. Capability advertisement may be included in a BGP OPEN message.

A BGP speaker that utilizes MP-BGP to carry label mapping information may use a BGP Capability Advertisement (e.g., the Capabilities Optional Parameter) to inform its BGP peers about its capability according to IETF RFC 2842, which is incorporated herein by reference. The Capabilities Optional Parameter may comprise a Capability Code field that advertises AFI and SAFI pairs, denotable as (AFI, SAFI), available on a particular connection between the BGP speaker and a BGP peer. A BGP speaker may use the new SAFI value to advertise its capability to support the new NLRI format 500. In an example embodiment, the BGP speaker may not advertise this capability to a BGP peer unless there is an LSP between the BGP speaker and its peer.

FIG. 6 is a flowchart of an example embodiment of a method 600 for BGP signaling. The method 600 may be implemented by first network element (e.g., a BGP speaker), which may be used in VPN communications, such as an MPLS label switch router (LSR), the PE device 230, and/or the transit router 235. At step 610, the method 600 may start BGP session negotiations and exchange BGP OPEN messages, wherein BGP Capability Advertisements are exchanged between the first network element (functioning as a BGP speaker) and one or more second network elements functioning as BGP peers. For example, during negotiation of the BGP session, which may be any type of BGP session, the BGP speaker may send or broadcast a BGP Capability Advertisement to a BGP peer. The BGP Capability Advertisement may comprise the SAFI value that informs the BGP peer of available AFI and SAFI pairs. The AFI and SAFI pairs may comprise the specific SAFI value and a corresponding AFI value to indicate that the first network element supports use of Big Label Values. In an example embodiment, the BGP speaker may not broadcast the BGP Capability Advertisement to BGP peers unless an LSP exists between the BGP speaker and a respective BGP peer. It should be understood that BGP hosts such as a BGP speaker and a BGP peer disclosed herein may be implemented as any suitable network elements, such as the PE device 230 and/or the transit router 235.

At step 620, the method 600 may establish a BGP session between the first network element and one or more of its BGP peers. In step 630, the method 600 may encode MPLS information in an NLRI label field (e.g., the label field 520) that is longer than 24 bits. The label field may be part of an NLRI format (e.g., the NLRI format 500). In an example embodiment, the NLRI may comprise the NLRI label field that comprises a MPLS label, an address prefix field; and a length indicator field. The NLRI label field may comprise a MPLS label (either a MPLS Big Label about 32 bits long or a conventional MPLS label no more than about 20 bits long and with padded zeroes), the variable address prefix field may comprise one or more address prefixes followed by trailing bits such that the variable length prefix occupies an integer number of octets, and the length indicator field may indicate a total length, in bits, of the MPLS label and the one or more address prefixes. The NLRI may contain no Big Label Indicator, Exp, S, or TTI values.

At step 640, the method 600 may transmit a BGP update message comprising a BGP attribute to a second network element functioning as a respective BGP peer. The BGP attribute, denoted as MP_REACH_NLRI, may comprise the NLRI and a specific SAFI value (e.g., between 9-63). The specific SAFI value may indicate or signal to the second network element, upon reception of the BGP update message by the second network element, that the NLRI label field is more than 24 bits long. The SAFI value distinguishes the NLRI from other NLRIs that do not contain Big Label Values. In an example embodiment, the SAFI value is a specific value assigned by the IANA.

At least one example embodiment is disclosed and variations, combinations, and/or modifications of the example embodiment(s) and/or features of the example embodiment(s) made by a person having ordinary skill in the art are within the scope of the disclosure. Alternative embodiments that result from combining, integrating, and/or omitting features of the example embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=R₁+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means +/−10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of Accordingly, the scope of protection is not limited by the description set out above but is defined by the claims that follow, that scope including all equivalents of the subject matter of the claims. Each and every claim is incorporated as further disclosure into the specification and the claims are example embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several example embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various example embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

We claim:

1. In virtual private network (VPN) communications, a method for Boarder Gateway Protocol (BGP) signaling implemented by a first network element, the method comprising:
encoding Multiprotocol Label Switching (MPLS) information in a Network Layer Reachability Information (NLRI) label field that is longer than 24 bits; and
transmitting a BGP update message comprising a BGP attribute to a second network element, wherein the BGP attribute comprises the NLRI and a specific Subsequent Address Family Identifier (SAFI) value, and wherein the specific SAFI value signals to the second network element, upon reception of the BGP update message by the second network element, that the NLRI label field is more than 24 bits long.

2. The method of claim 1, wherein the NLRI comprises:
the NLRI label field that comprises a MPLS label;
an address prefix field comprising one or more address prefixes followed by trailing bits such that the address prefix field occupies an integer number of octets; and
a length indicator field indicating a total length in bits of the MPLS label and the one or more address prefixes.

3. The method of claim 2, wherein the NLRI label field is about 32 bits long, wherein the MPLS label is no more than 20 bits long, and wherein the beginning bits of the NLRI label field before the MPLS label are set to zeroes.

4. The method of claim 2, wherein the MPLS label has a Big Label Value that is about 32 bits long, and wherein the Big Label Value indicates that the first network element supports mapping between VPN labels and more than about one million virtual network addresses.

5. The method of claim 4, wherein the BGP attribute is denotable as Multiprotocol Reachable Network Layer Reachability Information (MP_REACH_NLRI), and wherein the specific SAFI value distinguishes the NLRI from other NLRIs that do not contain Big Label Values.

6. The method of claim 5, wherein the specific SAFI value is assigned by the Internet Assigned Numbers Authority (IANA), and wherein the NLRI contains no Big Label Indicator.

7. The method of claim 4, wherein the MPLS information is encoded in the NLRI after establishment of a BGP session, wherein the method further comprises broadcasting a BGP Capability Advertisement to one or more second network elements during negotiations of the BGP session and prior to encoding of the MPLS information, wherein the BGP Capability Advertisement informs the one or more second network elements of Address Family Identifier (AFI) and SAFI pairs available at the first network element, and wherein the AFI and SAFI pairs comprise the specific SAFI value and a corresponding AFI value to indicate that the first network element supports use of Big Label Values.

8. The method of claim 7, wherein the first network element broadcasting the BGP Capability Advertisement in a BGP OPEN message is a BGP speaker, wherein the one or more second network elements are BGP peers, and wherein the BGP speaker does not advertise the BGP Capability Advertisement to the BGP peers unless a Label Switched Path (LSP) exists between the BGP speaker and a respective BGP peer.

9. A computer program product comprising computer executable instructions stored on a non-transitory computer readable medium such that when executed by a processor cause a first network element to:
encode Multiprotocol Label Switching (MPLS) information in a Network Layer Reachability Information (NLRI) label field that is longer than 24 bits; and
transmit a BGP update message comprising a BGP attribute to a second network element, wherein the BGP attribute comprises the NLRI label field and a specific Subsequent Address Family Identifier (SAFI) value, and wherein the specific SAFI value signals to the second network element, upon reception of the BGP update message by the second network element, that the NLRI label field is more than 24 bits long.

10. The computer program product of claim 9, wherein the NLRI comprises:
the NLRI label field that comprises a MPLS label;
an address prefix field comprising one or more address prefixes followed by trailing bits such that the address prefix field occupies an integer number of octets; and
a length indicator field indicating a total length in bits of the MPLS label and the one or more address prefixes.

11. The computer program product of claim 10, wherein the NLRI label field is about 32 bits long, wherein the MPLS label is no more than 20 bits long, and wherein the beginning bits of the NLRI label field before the MPLS label are set to zeroes.

12. The computer program product of claim 10, wherein the MPLS label has a Big Label Value that is about 32 bits long.

13. The computer program product of claim 12, wherein the BGP attribute is denotable as Multiprotocol Reachable Network Layer Reachability Information (MP_REACH_NLRI), and wherein the specific SAFI value distinguishes the NLRI from other NLRIs that do not contain Big Label Values.

14. The computer program product of claim 13, wherein the SAFI value is a specific value assigned by the Internet Assigned Numbers Authority (IANA), and wherein the NLRI contains no Big Label Indicator.

15. The computer program product of claim 13, wherein the MPLS information is encoded in the NLRI after establishment of a BGP session, wherein the computer program product further comprises instructions that cause the network element to broadcast a BGP Capability Advertisement to one or more second network elements during negotiations of the BGP session and prior to encoding of the MPLS information, wherein the BGP Capability Advertisement informs the one or more second network elements of Address Family Identifier (AFI) and SAFI pairs available at the first network element, and wherein the AFI and SAFI pairs comprise the specific SAFI value and a corresponding AFI value to indicate that the first network element supports use of Big Label Values.

16. The computer program product of claim 15, wherein the first network element broadcasting the BGP Capability Advertisement is a BGP speaker, wherein the one or more second network elements are BGP peers, and wherein the BGP speaker does not advertise the BGP Capability Advertisement to the BGP peers unless a Label Switched Path (LSP) exists between the BGP speaker and a respective BGP peer.

17. An apparatus used in Multiprotocol Extensions for BGP Version 4 (BGP-4) (MP-BGP), the apparatus comprising:
a processor configured to encode Network Layer Reachability Information (NLRI) comprising:
a Label field that carries a 4-octet Big Label Value;
a Prefix field that contains one or more address prefixes followed by enough trailing bits to make the end of the Prefix field fall on an octet boundary; and
a Length field that indicates a total length in bits of the Big Label Value plus the one or more address prefixes; and
a transmitter coupled to the processor and configured to transmit a BGP update message to a network element, wherein the BGP update message comprises the NLRI and a Subsequent Address Family Identifier (SAFI) value, and wherein the SAFI value indicates to the network element that the NLRI carries the Big Label Value.

18. The apparatus of claim 17, wherein the processor is further configured to encode a Multiprotocol Label Switching (MPLS) packet for forwarding, and wherein the encoded MPLS packet comprises a Big Label Indicator and the Big Label Value.

19. The apparatus of claim 17, wherein the apparatus serves as a BGP speaker that uses MP-BGP to carry label mapping information, wherein the processor is further configured to use a Capabilities Optional Parameter, via the transmitter, to inform one or more BGP peers about capabilities of the BGP speaker prior to encoding the NLRI, and wherein the Capabilities Optional Parameter comprises a Capability Code field that advertises Address Family Identifier (AFI) and SAFI pairs available on a particular connection between the BGP speaker and a respective BGP peer.

20. The apparatus of claim 19, wherein the SAFI value is assigned by the Internet Assigned Numbers Authority (IANA), and wherein the BGP speaker does not advertise its capabilities to the BGP peers unless there is a Label Switched Path (LSP) between the BGP speaker and the respective BGP peer.
